(19) United States
(12) Patent Application Publication
(10) Pub. No.: US 2024/0296394 A1
(43) Pub. Date: Sep. 5, 2024

(54) DATA ANALYSIS METHOD, APPARATUS, DEVICE AND MEDIUM

(71) Applicant: Beijing Volcano Engine Technology Co., Ltd., Haidian District, Beijing (CN)

(72) Inventors: Jun Xing, Beijing (CN); Xiaoming Zhao, Beijing (CN); Yingchun Zou, Beijing (CN); Xuan Luo, Beijing (CN)

(21) Appl. No.: 18/593,321

(22) Filed: Mar. 1, 2024

(30) Foreign Application Priority Data
Mar. 1, 2023 (CN) 202310225097.5

(51) Int. Cl. G06Q 10/063

(52) U.S. Cl. CPC G06Q 10/063

(57) ABSTRACT

The present disclosure provides a data analysis method, an apparatus, a device, and a computer-readable storage medium. The method includes acquiring a data analysis request, in which the data analysis request includes at least one data indicator; analyzing the at least one data indicator according to a calculation model of the at least one data indicator to obtain a basic indicator on which the at least one data indicator depends, in which the calculation model comprises a dependency relationship between the at least one data indicator and the basic indicator; and according to a query result of the basic indicator, performing calculation on the query result of the basic indicator through the calculation model to obtain a query result of the at least one data indicator.

### CROSS-REFERENCE TO RELATED APPLICATION

The present application claims the priority to Chinese Patent Application No. 202310225097.5, filed on Mar. 1, 2023, the entire disclosure of which is incorporated herein by reference as portion of the present application.

### TECHNICAL FIELD

The present disclosure relates to the field of computer technology, more particularly to a data analysis method, an apparatus, a device, and a computer-readable storage medium.

### BACKGROUND

With the rapid development of computer technology and the gradual increase in data scale, utilizing data for data analysis can assist businesses in management and decision-making, thereby realizing commercial value. Data analysis refers to the process of applying statistical analysis methods to analyze data, extract information contained in the data, and use this data to discover laws and solve problems.

To meet the requirements of data analysis, business intelligence (BI) products have emerged. BI products enable users to perform data analysis by constructing query statements. If the indicators users wish to analyze cannot be directly obtained from the data tables, the users can configure the calculation methods for these data indicators themselves, thereby achieving multifaceted data analysis through different indicators.

However, current BI products have limitations in the nested relationships of data indicators, and there is insufficient support for data indicators with complex nested relationships, which reduces the flexibility of data analysis in BI products and makes it difficult to meet user requirements.

### SUMMARY

The present disclosure provides a data analysis method, the data analysis method can make the configuration and calculation of data indicators more flexible, to meet various business requirements. The present disclosure further provides an apparatus, a device, a computer-readable storage medium, and a computer program product corresponding to the above-mentioned method.

In the first aspect, the present disclosure provides a data analysis method, the method includes:
acquiring a data analysis request, in which the data analysis request includes at least one data indicator;
analyzing the at least one data indicator according to a calculation model of the at least one data indicator to obtain a basic indicator on which the at least one data indicator depends, in which the calculation model includes a dependency relationship between the at least one data indicator and the basic indicator; and
according to a query result of the basic indicator, performing calculation on the query result of the basic indicator through the calculation model to obtain a query result of the at least one data indicator.

In some possible implementations, the method further includes:
receiving an attribute of the at least one data indicator configured by a user through a configuration interface, in which the attribute comprises an identification and a calculation method of the at least one data indicator; and
constructing the calculation model of the at least one data indicator according to the identification and the calculation method.

In some possible implementations, the analyzing the at least one data indicator according to the calculation model of the at least one data indicator to obtain the basic indicator on which the at least one data indicator depends, includes:
according to the calculation model of the at least one data indicator, determining an indicator on which the at least one data indicator depends, in which the indicator on which the at least one data indicator depends comprises one or more of an intermediate result indicator and a basic indicator; and
filtering the basic indicator on which the at least one data indicator depends, from the indicator on which the at least one data indicator depends.

In some possible implementations, the indicator on which the at least one data indicator depends includes an intermediate result indicator and a basic indicator, and according to the query result of the basic indicator, the performing calculation on the query result of the basic indicator through the calculation model to obtain the query result of the at least one data indicator, includes:
according to the query result of the basic indicator, performing calculation on the query result of the basic indicator based on a dependency relationship between the intermediate result indicator and the basic indicator, to obtain a query result of the intermediate result indicator; and
performing calculation on the query result of the intermediate result indicator based on a dependency relationship between the at least one data indicator and the intermediate result indicator, to obtain the query result of the at least one data indicator.

In some possible implementations, the method further includes:
converting the calculation model of the at least one data indicator into a domain model, in which the domain model comprises an indicator on which the at least one data indicator depends and a calculation method of the at least one data indicator; and
according to the query result of the basic indicator, the performing calculation on the query result of the basic indicator through the calculation model to obtain the query result of the at least one data indicator, includes:
according to the query result of the basic indicator, performing calculation on the query result of the basic indicator based on the indicator on which the at least one data indicator depends in the domain model and the calculation method of the at least one data indicator in the domain model, to obtain the query result of the at least one data indicator.

In some possible implementations, the method further includes:
generating a chart corresponding to a type of the at least one data indicator according to the query result of the at least one data indicator; and
presenting the chart corresponding to the type of the at least one data indicator to a user.

In some possible implementations, the calculation model of the at least one data indicator is represented by a directed acyclic graph (DAG), a vertex of the DAG represents an identification, and an edge of the DAG represents a calculation method.

In the second aspect, the present disclosure provides a data analysis apparatus, the apparatus includes:
an acquisition unit, configured to acquire a data analysis request, in which the data analysis request comprises at least one data indicator;
an analyzing unit, configured to analyze the at least one data indicator according to a calculation model of the at least one data indicator to obtain a basic indicator on which the at least one data indicator depends, in which the calculation model includes a dependency relationship between the at least one data indicator and the basic indicator; and
a calculation unit, configured to, according to a query result of the basic indicator, perform calculation on the query result of the basic indicator through the calculation model to obtain a query result of the at least one data indicator.

In some possible implementations, the apparatus further includes:
a construction unit, configured to receive an attribute of the at least one data indicator configured by a user through a configuration interface, in which the attribute includes an identification and a calculation method of the at least one data indicator; and construct the calculation model of the at least one data indicator based on the identification and the calculation method.

In some possible implementations, the analyzing unit is specifically configured to:
determine, according to the calculation model of the at least one data indicator, an indicator on which the at least one data indicator depends, in which the indicator on which the at least one data indicator depends includes one or more of an intermediate result indicator and a basic indicator; and
filter the basic indicator on which the at least one data indicator depends, from the indicator on which the at least one data indicator depends.

In some possible implementations, the indicator on which the at least one data indicator depends includes an intermediate result indicator and a basic indicator, and the calculation unit is specifically configured to:
perform calculation on the query result of the basic indicator based on a dependency relationship between the intermediate result indicator and the basic indicator, to obtain a query result of the intermediate result indicator; and
perform calculation on the query result of the intermediate result indicator based on a dependency relationship between the at least one data indicator and the intermediate result indicator, to obtain the query result of the at least one data indicator.

In some possible implementations, the apparatus further includes:
a conversion unit, configured to convert the calculation model of the at least one data indicator into a domain model, in which the domain model includes an indicator on which the at least one data indicator depends and a calculation method of the at least one data indicator; and
the calculation unit is specifically configured to:
perform calculation on the query result of the basic indicator, based on the indicator on which the at least one data indicator depends in the domain model and the calculation method of the at least one data indicator in the domain model, to obtain the query result of the at least one data indicator.

In some possible implementations, the apparatus further includes:
a presentation unit, configured to generate a chart corresponding to a type of the at least one data indicator according to the query result of the at least one data indicator; and present the chart corresponding to the type of the at least one data indicator to a user.

In some possible implementations, the calculation model of the at least one data indicator is represented by a directed acyclic graph (DAG), a vertex of the DAG represents an identification, and an edge of the DAG represents a calculation method.

In the third aspect, the present application provides a device including a processor and a memory. The processor and the memory communicate with each other. The processor is configured to execute instructions stored in the memory to enable the device to perform the data analysis method as described in the first aspect or any one of the implementations of the first aspect.

In the fourth aspect, the present disclosure provides a computer-readable storage medium, the computer-readable storage medium stores instructions, and the instructions are configured to instruct a device to perform the data analysis method as described in the first aspect or any one of the implementations of the first aspect.

In the fifth aspect, the present disclosure provides a computer program product containing instructions, and when the computer program product is run on a device, the device is allowed to perform the data analysis method as described in the first aspect or any one of the implementations of the first aspect.

Based on the implementations provided in the above-mentioned aspects, the implementations of the present disclosure can also be further combined to provide additional implementations.

### BRIEF DESCRIPTION OF DRAWINGS

In order to more clearly illustrate the technical methods of the embodiments of the present disclosure, the drawings required for the embodiments will be briefly introduced below.

FIG. 1 is an architectural diagram of a data analysis system provided by the embodiments of the present disclosure;

FIG. 2 is a flowchart of a data analysis method provided by the embodiments of the present disclosure;

FIG. 3A is a schematic diagram of a data indicator configuration interface provided by the embodiments of the present disclosure;

FIG. 3B is a schematic diagram of another data indicator configuration interface provided by the embodiments of the present disclosure;

FIG. 4 is a schematic structural diagram of a calculation model provided by the embodiments of the present disclosure.

FIG. 5 is a schematic diagram of a calculation model in an e-commerce application scenario provided by the embodiments of the present disclosure;

FIG. 6 is a schematic diagram of a domain model provided by the embodiments of the present disclosure;

FIG. 7 is a flowchart of another data analysis method provided by the embodiments of the present disclosure;

FIG. 8 is a schematic structural diagram of a data analysis apparatus provided by the embodiments of the present disclosure; and

FIG. 9 is a schematic structural diagram of a device provided by the embodiments of the present disclosure.

### DETAILED DESCRIPTION

In the embodiments of the present disclosure, the terms “first,” “second,” and the like are used for descriptive purposes only and should not be construed as indicating or implying relative importance or implicitly indicating the quantity of the technical features. Therefore, features defined with “first,” “second” can explicitly or implicitly include one or more of such features.

First, some technical terms involved in the embodiments of the present disclosure are introduced.

Data analysis refers to the use of statistical analysis methods to analyze data, to develop the functions of data, to make good use of the data, thereby extracting the information contained in the data for study and generalization. The purpose of data analysis is to concentrate and extract the information hidden in the data, to discover the inherent laws using the data, and use the inherent laws to solve problems. In practical applications, data analysis can help users (such as businesses) make decisions to take appropriate actions.

Business intelligence (BI), also known as business acumen or business savvy, refers to the use of modern data warehouse technology, online analytical processing (OLAP) technology, data mining technology, and data presentation technology to analyze data, thereby realizing commercial value. Utilizing BI products for data analysis can assist users (such as businesses) in management and decision-making processes.

When using BI products, the user(s) can perform data analysis by constructing query statements. For example, the user(s) can construct query statements that query the sales of a product A over the past week, so as to perform data analysis on the product A through the sales indicator. If the indicator the user wants to analyze cannot be directly acquired from the data table, the user can configure the calculation method of the data indicator to achieve data analysis. For example, if the data table includes three basic indicators: product name, date, and sales, and the user wants to analyze the sales ratio of different products over the past week, this indicator cannot be directly acquired from the basic indicators in the data table. Therefore, the user can configure a data indicator “sales ratio,” and configure a calculation method of the data indicator: the sales of a certain product over the past week divided by the total sales of all products over the past week, so as to perform data analysis on the sales ratio of the product through the sales ratio indicator.

However, current BI products have limitations in the nested relationships of data indicators. For the data indicators with complex nested relationships, such as indicators like year-on-year (YoY) and month-on-month (MoM) comparisons that require querying the same basic indicator over different time periods, or indicators like year-on-year sorting that require calculating the YoY indicator and then further sorting the YoY indicator, the current BI products are difficult to configure, which reduces the flexibility of data analysis of the BI products, and it is difficult to meet the multifaceted needs of users.

In view of this, the embodiments of the present disclosure provide a data analysis method, the method is to acquire the data analysis request first, in which the data analysis request includes at least one data indicator; then analyze the at least one data indicator according to the calculation model of the at least one data indicator to obtain the basic indicator on which the at least one data indicator depends, in which the calculation model includes the dependency relationship between the at least one data indicator and the basic indicator; and then, according to the query result of the basic indicator, perform calculation on the query result of the basic indicator through the calculation model to obtain the query result of the at least one data indicator.

For example, the method may be executed by a server. Specifically, the server first acquires a data analysis request, in which the data analysis request includes at least one data indicator. Then the server analyzes the at least one data indicator according to a calculation model of the at least one data indicator, to obtain a basic indicator on which the at least one data indicator depends, in which the calculation model includes a dependency relationship between the at least one data indicator and the basic indicator. Next, the server, according to a query result of the basic indicator, performs calculation on the query result of the basic indicator through the calculation model to obtain a query result of the at least one data indicator.

The method constructs the calculation model that includes the dependency relationship between the data indicator and other indicators, thus obtaining the basic indicator on which the data indicator depends by analyzing the calculation model. In this way, the query result of the basic indicator can be calculated based on the calculation model to obtain the query result of the data indicator, thereby causing the configuration and calculation of the data indicator more flexible, supporting data analysis of data indicators with complex nested relationships, and meeting various business requirements.

In order to make the technical solutions of the present disclosure clearer and easier to understand, a system architecture of a data analysis method provided by the embodiments of the present disclosure is described below in conjunction with the drawings.

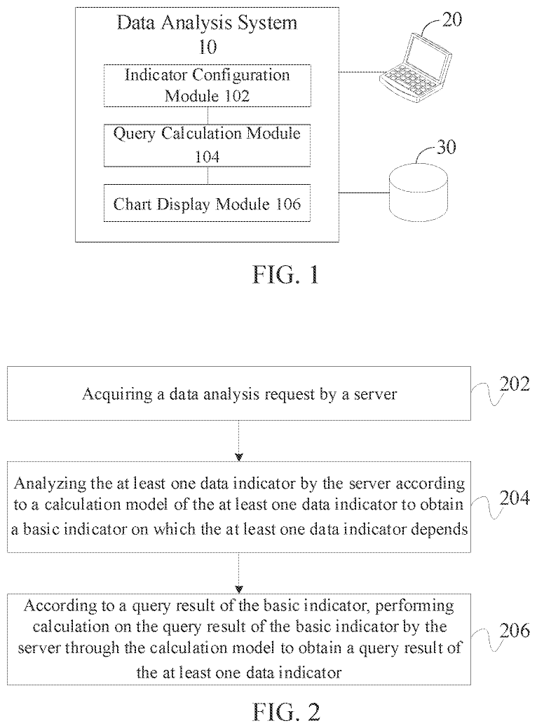

Referring to a schematic diagram of an architecture of a data analysis system 10 shown in FIG. 1, the data analysis system 10 includes an indicator configuration module 102, a query calculation module 104, and a chart display module 106. The data analysis system 10 may be a software system that may be deployed on a server. The server executes the program codes of the software system to perform the data analysis method provided by the embodiments of the present disclosure. In some possible implementations, the data analysis system 10 may also be a hardware system with data analysis functions. When the hardware system is operating, the data analysis method provided by the embodiments of present disclosure is performed. For example, the data analysis system 10 may be a server with data analysis functions. The server may be a cloud server, for example, a central server in a central cloud computing cluster, or an edge server in an edge cloud computing cluster. Of course, the server may also be a server in a local data center, in which the local data center refers to a data center directly controlled by the user.

Specifically, the indicator configuration module 102 is configured to receive the attribute of the data indicator configured by the user, in which the attribute of the data indicator includes an identification and a calculation method of the data indicator. In some possible implementations, the data analysis system 10 may be connected to a terminal 20. The terminal 20 includes, but is not limited to, smart phones, tablets, laptops, personal digital assistants (PDAs), or smart wearable devices, etc. In this case, the user can configure the attribute of the data indicator through a configuration interface on the terminal 20. Furthermore, the indicator configuration module 102 can construct a corresponding calculation model according to the attribute of the data indicator. This calculation model can store the dependency relationship between the data indicator and the basic indicator, to facilitate data analysis utilizing the calculation model.

The query calculation module 104 can acquire the data analysis request, and the data analysis request may include the at least one data indicator. It should be noted that in the embodiments of the present disclosure, there are no limitations on the source of the data analysis request. For example, the data analysis request may be a data analysis request initiated by a user through the terminal 20. For another example, the data analysis request may also be a data analysis request sent by another application (APP) calling an interface of the data analysis system 10.

In addition, the query calculation module 104 can analyze the data indicator according to the calculation model of the data indicator to obtain the basic indicator on which the data indicator depends.

In addition, the data analysis system 10 may be connected to a data source 30. It should be noted that in the embodiments of the present disclosure, there are no limitations on the type of the data source. For example, the data source 30 may include a database data source, a file data source, and an application programming interface (API) data source. The query calculation module 104 can query the basic indicator in the data source 30 to obtain the query result of the basic indicator, and then perform calculation on the query result according to the calculation model to obtain the query result of the data indicator.

The chart display module 106 can generate a chart corresponding to the type of the data indicator according to the query result of the data indicator, and present the chart to the user on the terminal 20, thus displaying the data analysis result to the user.

The data analysis system 10 for performing the data analysis method has been described above, and next, the data analysis method provided by the embodiments of the present disclosure will be described in detail by taking the data analysis system 10 deployed in a server as an example.

Please refer to a flowchart of a data analysis method shown in FIG. 2, the method includes the following steps.

S202: acquiring a data analysis request by a server.

Data analysis needs to be performed based on a data source, and in the embodiments of the present disclosure, a plurality of data sources may be deployed in the server. For example, the types of the plurality of data sources may be one or more of a database data source, a file data source, and an API data source. Specifically, the database data source may include a plurality of data sources such as MySQL, SQL Server, Oracle, and the like, and the embodiments of the present disclosure are not limited thereto. The file data source may include a file stored locally, for example, an excel file or a comma-separated values (CSV) file. The API data source may include a data source obtained by calling an API, for example, a data source obtained by configuring a uniform resource locator (URL) of the API.

In addition, the data source may include at least one data table, and the data table may include raw data. Specifically, the raw data in the data table may include data of at least one field. For example, the data table may include data of a plurality of fields such as a store name, a date, a daily flow, a live broadcast duration, and the like. The raw data in the data table may be directly acquired through querying, for example, the raw data may be queried through a field name. For ease of understanding, in the embodiments of the present disclosure, the field in the data table is referred to as the basic indicator, that is, the data table includes data of at least one basic indicator.

The data analysis request may include at least one basic indicator. For example, the data analysis request may be to query the daily sales of a store A. In response to a data analysis request that includes at least one basic indicator, the server can directly query the basic indicator from the data table, and obtain the query result of the basic indicator, thereby completing the data analysis.

In the embodiments of the present disclosure, the data analysis request includes at least one data indicator. Corresponding to the basic indicator, the data indicator refers to an indicator that cannot be directly acquired from the data table by querying. For example, the data indicator may be the revenue per unit of time, and the data indicator needs to be obtained by calculating two basic indicators of daily revenue and live broadcasting duration. For another example, the data indicator may be a sorting value of the week-on-week comparison of live broadcasting duration, the data indicator needs to first calculate the week-on-week comparison of live broadcasting duration, and then sort the week-on-week comparison of live broadcasting duration for each store to obtain the sorting value of the week-on-week comparison of live broadcasting duration.

S204: analyzing the at least one data indicator by the server according to a calculation model of the at least one data indicator to obtain a basic indicator on which the at least one data indicator depends.

The calculation model includes the dependency relationship between the at least one data indicator and the basic indicator.

It may be understood that because the data indicator cannot be directly acquired from the data table by querying, it is necessary for users to configure the data indicator to facilitate data analysis.

In some possible implementations, the server may receive an attribute of the at least one data indicator configured by the user through a configuration interface, in which the attribute includes an identification and a calculation method of the at least one data indicator; then, the server may construct a calculation model of the at least one data indicator according to the identification and the calculation method.

Specifically, the calculation method of the data indicator includes indicators involved in the calculation and the arithmetic relationship of the indicators. The indicators involved in the calculation may be basic indicators or configured data indicators, and the arithmetic relationship of the indicators may be one or more of the four operations, connection, merging, aggregation, filtering, sorting, and custom functions. Users can configure the calculation method of the data indicators according to the actual situation to meet different data analysis requirements.

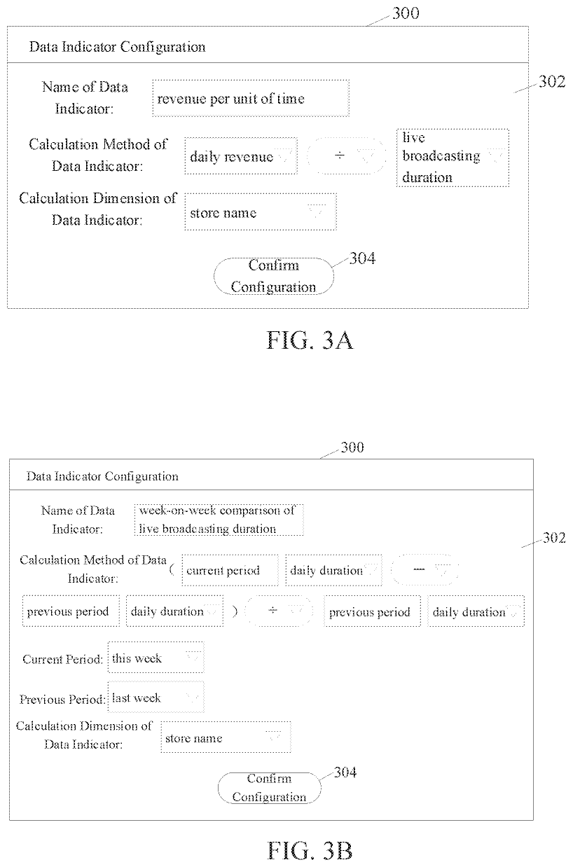

Next, the process of configuring the data indicator by a user will be explained in detail, in conjunction with schematic diagrams of data indicator configuration interfaces shown in FIG. 3A and FIG. 3B.

The data indicator configuration interface 300 shown in FIG. 3A includes an indicator attribute configuration region 302 and a confirm configuration control 304. In the indicator attribute configuration region 302, the user can configure the name (i.e., identification) and calculation method of the data indicator. For example, the user may configure the name of the data indicator as “revenue per unit of time”, and configure the calculation method of the data indicator as “daily revenue divided by live broadcasting duration”. Here, the user can configure the arithmetic relationship of the indicator using a dropdown menu method.

In some embodiments, when configuring the data indicator, the user can further configure the calculation dimension of the data indicator. For example, the user can configure the calculation dimension of the data indicator as “store name,” so that the result can be presented and categorized by store name during data analysis. In some possible implementations, the calculation dimension of the data indicator may also be the date, region, age, etc., and the embodiments of the present disclosure are not limited in this aspect.

In addition, the user can further configure the data indicator for which a time range needs to be configured. Please refer to a schematic diagram of a data indicator configuration interface shown in FIG. 3B.

The data indicator configuration interface 300 shown in FIG. 3B includes an indicator attribute configuration region 302 and a confirm configuration control 304. In the indicator attribute configuration region 302, the user can configure the name (i.e., identification) and calculation method of the data indicator. Similarly, the user can further configure the calculation dimension of the data indicator.

In the case where the data indicator configured by the user requires configuring a time range (for example, the data indicator is year-over-year or quarter-over-quarter comparison), the user can further configure the time range in the indicator attribute configuration region 302. For example, if the user configures the name of the data indicator as “week-on-week comparison of live broadcasting duration”, the calculation method of the data indicator is “(daily duration of current period-daily duration of previous period)/daily duration of previous period”. In this case, the user can configure the time range (i.e., the current period and the previous period). For example, the current period may be this week, and the previous period may be last week.

In some embodiments, the time range may also be a specific date range, and the embodiments of the present disclosure are not limited in this aspect. For example, the current period may be “Feb. 10, 2023 to Feb. 16, 2023” and the previous period may be “Feb. 3, 2023 to Feb. 9, 2023”.

In addition, the server can construct the calculation model of the data indicator according to the attribute of the data indicator configured by the user. In some possible implementations, the calculation model may be represented by a directed acyclic graph (DAG), in which the vertex of the DAG may represent the identification, and the edge of the DAG may represent the calculation method.

In some possible implementations, after acquiring the data analysis request, the server can determine, according to the calculation model of the at least one data indicator, an indicator on which the at least one data indicator depends, and filter the basic indicator on which the at least one data indicator depends, from the indicator on which the at least one data indicator depends. The indicator on which the at least one data indicator depends includes one or more of an intermediate result indicator and a basic indicator.

Referring to a schematic structural diagram of a calculation model shown in FIG. 4, the calculation model is represented by a DAG, and the DAG may include three types of vertices: a basic indicator vertex, an intermediate result indicator vertex, and a data indicator vertex. The basic indicator vertex may include a basic indicator i, a basic indicator i′, a basic indicator j, and a basic indicators k. Here, the basic indicator i and the basic indicator i′ may represent the basic indicator i under different time ranges. Because the basic indicator can be directly acquired from the data table by querying, the basic indicator vertex may also be referred to as a fetching node. The intermediate result indicator vertex may include the data indicator; for example, the intermediate result indicator vertex may include a data indicator A, a data indicator B, a data indicator C, a data indicator X, and a data indicator Y. Because the intermediate result indicator cannot be directly acquired from the data table by querying, but need to be acquired through calculation, the intermediate result indicator vertex may also be referred to as a calculation node. The data indicator vertex may be the vertex corresponding to the data indicator included in the data analysis request. Because the data indicator vertex is the data indicator to be analyzed in the data analysis request, the data indicator vertex may also be referred to as a result assembly node.

In addition, the direction of the edge of the DAG may represent the dependency relationship between vertices. For example, the edge of the data indicator A pointing to the basic indicator i and the basic indicator i′ indicate that the data indicator A depends on the basic indicator i and the basic indicator i′, that is, the data indicator A requires the query results of the basic indicator i and the basic indicator i′ for calculation.

By constructing the calculation model of the data indicator, the dependency relationship and calculation logic between the data indicator and the basic indicator can be intuitively deduced. When users configure new data indicators, the server can expand the data indicator by adding new vertices and edges to the existing calculation model, thereby realizing data analysis of data indicators with complex nested relationships.

In response to the data analysis request, the server can determine the indicator on which the data indicator depends through the calculation model (for example, through the vertex and edge in the DAG), thereby filtering the basic indicator on which the data indicator depends from the indicator on which the data indicator depends. For example, the server can determine the indicator with an outdegree of 0 among the indicators on which the data indicator depends as the basic indicator on which the data indicator depends.

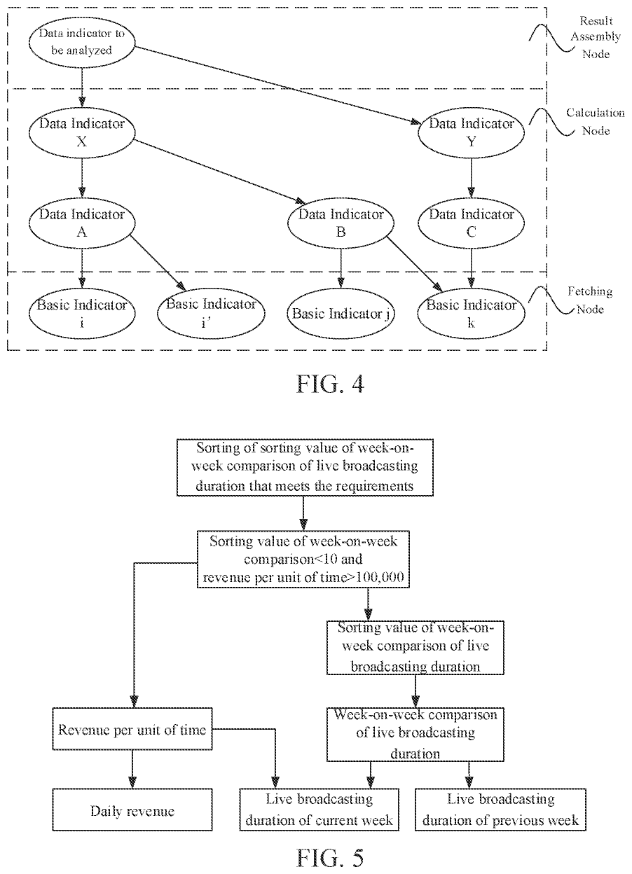

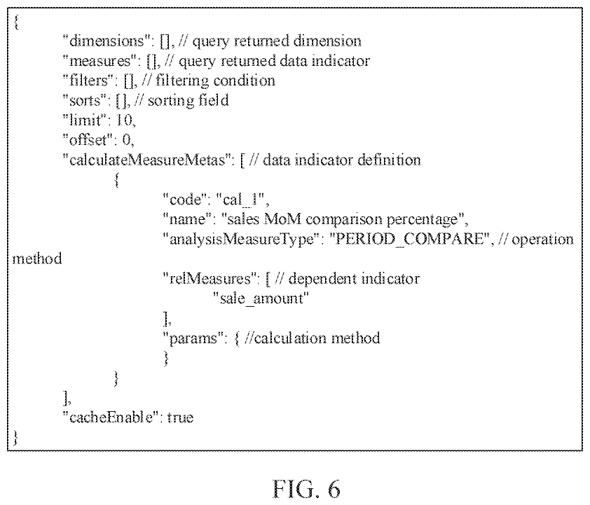

Next, for ease of understanding, a schematic diagram of a calculation model in an e-commerce application scenario, as shown in FIG. 5, will be introduced.

In this calculation model, the basic indicator vertex includes daily revenue, live broadcasting duration of current week, and live broadcasting duration of previous week. The intermediate result indicator vertex includes revenue per unit of time, week-on-week comparison of live broadcasting duration, sorting value of week-on-week comparison of live broadcasting duration and filtering the sorting value of week-on-week comparison, and revenue per unit of time. The data indicator vertex includes the sorting of the sorting value of week-on-week comparison of live broadcasting duration that meets the requirements.

It can be understood that the data indicator included in the data analysis request is the sorting of the sorting value of week-on-week comparison of live broadcasting duration that meets the requirements. The intermediate result indicators on which the data indicator depends are revenue per unit of time, week-on-week comparison of live broadcasting duration, sorting value of week-on-week comparison of live broadcasting duration and filtering the sorting value of week-on-week comparison, and revenue per unit of time. The basic indicators on which the revenue per unit of time depends are daily revenue and live broadcasting duration of current week, and the basic indicators on which the week-on-week comparison of live broadcasting duration depends are live broadcasting duration of current week and live broadcasting duration of previous week. Therefore, by analyzing the calculation model, the basic indicators, on which the data indicator depends, obtained by the server are daily revenue, live broadcasting duration of current week and live broadcasting duration of previous week.

S206: according to a query result of the basic indicator, performing calculation on the query result of the basic indicator by the server through the calculation model to obtain a query result of the at least one data indicator.

Because the basic indicator can be directly acquired from the data table by querying, the server can query the basic indicator in the data table to obtain the query result of the basic indicator. Next, the server can perform calculation on the query result through the calculation model of the data indicator to obtain the query result of the data indicator.

In some possible implementations, the indicator on which the data indicator depends includes an intermediate result indicator and a basic indicator, and the server can perform calculation on the query result of the basic indicator based on the dependency relationship between the intermediate result indicator and the basic indicator, to obtain the query result of the intermediate result indicator. Then, the server can perform calculation on the query result of the intermediate result indicator based on the dependency relationship between the data indicator and the intermediate result indicator, to obtain the query result of the data indicator.

Specifically, the server can analyze the calculation model of the data indicator to obtain a linear order calculation structure from the data indicator to the basic indicator, in which the linear order calculation structure can represent the calculation order of the data indicators; then, the server can query the basic indicator, and perform calculation on the query result of the intermediate result indicator according to the linear order calculation structure; and further calculate to obtain the query result of the data indicator.

Specifically, in the case where the calculation model is represented by a DAG, the server can obtain a linear sequence (i.e., a linear order calculation structure) from the data indicator to the basic indicator through topological sorting, so that the server can calculate to obtain the query result of the intermediate result indicator according to the query result of the basic indicator and the linear sequence, and then calculate to obtain the query result of the data indicator according to the query result of the intermediate result indicator and the linear sequence.

In some possible implementations, the server can convert the calculation model of at least one data indicator into a domain model, and the domain model includes an indicator on which the at least one data indicator depends and a calculation method of the at least one data indicator. Specifically, according to the query result of the basic indicator, the server can perform calculation on the query result of the basic indicator, based on the indicator on which the at least one data indicator depends in the domain model and the calculation method of the at least one data indicator in the domain model, to obtain the query result of the at least one data indicator.

In some embodiments, the domain model may be represented using a domain-specific language (DSL). DSL is a computer language specialized for a particular application field. Using DSL can present solutions to problems in a concise way, making it easier for developers to develop and communicate with experts in the application field.

In the following, the domain model in the embodiments of the present disclosure will be described in conjunction with a schematic diagram of a domain model shown in FIG. 6.

Referring to the domain model shown in FIG. 6, the domain model includes a data indicator definition part “calculateMeasureMetas”. In the data indicator definition part, the indicator on which the data indicator depends is specified through “relMeasures”. For example, for the data indicator “sales MoM comparison percentage”, the dependent indicator is “sale_amount”. In some embodiments, a pointer of the data indicator may be directed towards a list of dependent indicators, thereby indicating the dependency relationship between the data indicator and the intermediate result indicator as well as the basic indicator. In addition, in the data indicator definition part, the calculation method of the data indicator is specified through “params”, thus enabling the calculation of the data indicator.

In some possible implementations, the server may further generate a chart corresponding to the type of the at least one data indicator according to the query result of the at least one data indicator, and present the chart corresponding to the type of the at least one data indicator to the user.

Specifically, in order to facilitate the user's intuitive perception of the data analysis results, the server can generate a corresponding chart according to the type of the data indicator. For example, in the case where the type of the data indicator is a decimal type, the server may convert the decimal type to a percentage format and present it to the user in the form of a pie chart.

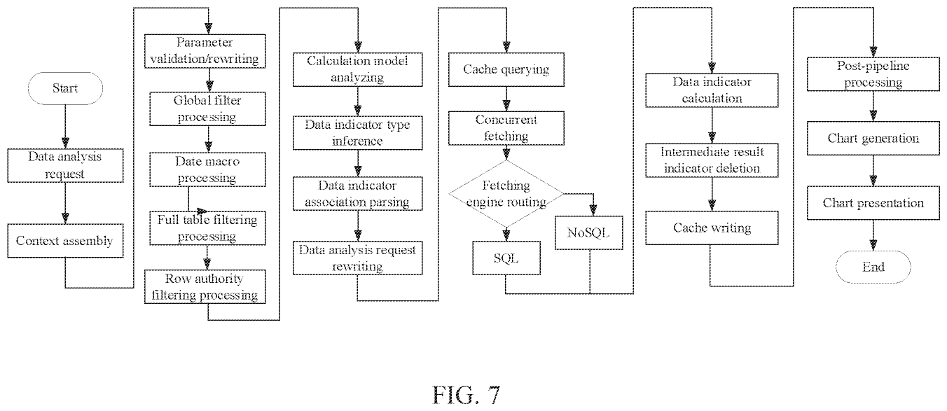

In order to facilitate the understanding of the data analysis method provided by the embodiments of the present disclosure, the flow of the data analysis method will be described in detail below in conjunction with FIG. 7.

In the embodiments of the present disclosure, data analysis may be divided into several stages: input preprocessing, pre-processing, calculation model analyzing, basic indicator querying, data indicator calculation, and post-processing and output.

Specifically, in the input preprocessing stage, the server can receive a data analysis request and then perform context assembly for the data analysis request. For example, the server can determine the data source and data table that may be used during the data analysis process based on the data analysis request, thereby achieving automatic assembly of context.

In addition, in the pre-processing stage, the server can perform several steps including parameter validation/rewriting, global filter processing, date macro processing, full table filtering processing, and row authority filtering processing. Specifically, the server can verify whether the parameters included in the data analysis request are illegal, in this case, the server can rewrite the data analysis request when the data analysis request does not satisfy a limit condition (e.g., does not satisfy a data volume limit for return results).

Additionally, the server may perform global filter processing according to the global filtering condition (such as only query data related to the city A).

In the case where the data analysis request includes a time range, the server may further perform the date macro processing on the data analysis request (e.g., if the time range configured in the data indicator included in the data analysis request is the past 7 days, then the server can determine the specific dates for the past 7 days).

Additionally, the server may perform full table filtering processing for the data sources (e.g., data warehouses) involved in the data analysis request (e.g., limiting queries only to the most recent partitions in the data warehouse, without the need to query historical partitions).

The server may further perform row authority filtering processing on the data analysis request according to the user's identity authority, thereby limiting the data range that the user can query within the data source.

In addition, during the calculation model analyzing stage, the server may perform several steps including calculation model analyzing, data indicator type inference, data indicator association analyzing, and data analysis request rewriting. Specifically, the server can analyze the data indicator (e.g., topological sorting) based on the calculation model of the data indicator, thus obtaining a linear order calculation structure from the data indicator to the basic indicator. If a currently traversed node appears in the already traversed path during the topological sorting process, it indicates that there is a circular dependency in the calculation model, and an alert can be issued to the user in this case.

Additionally, the server can infer the type of the data indicator based on the indicator on which the data indicator depends or the calculation method of the data indicator. For example, if the indicators on which the data indicator depends are all integer-type indicators, and the calculation method is addition and subtraction, it can be inferred that the type of the data indicator is also integer-type. For another example, if the calculation method of the data indicator is MoM comparison, it can be inferred that the type of the data indicator is the decimal type.

In the case where the indicators on which the data indicator depends include the same basic indicator in different time ranges, the server may further analyze the calculation model to determine that the basic indicator needs to be queried multiple times in different time ranges during subsequent queries of basic indicators.

Additionally, the server may further rewrite the data analysis request based on the data indicator to avoid the issue of missing associated data when calculating the data indicator. For example, in the case where the data indicator is YoY comparison or MoM comparison, the server may perform date alignment and accordingly rewrite the filtering condition, filtering number limit, sorting field, etc. in the data analysis request.

In addition, during the basic indicator querying stage, the server may perform several steps including cache querying, concurrent fetching, and fetching engine routing. Specifically, the server may first query the basic indicator in the cache; if the query result is not obtained, the server may concurrently query the basic indicator (i.e., execute fetching nodes concurrently) to obtain the query result of the basic indicator. For example, the server may query the basic indicator from the structured query language server database (SQL) and not only SQL (NoSQL) to obtain the query result.

In addition, during the data indicator calculation stage, the server may perform several steps including data indicator calculation, intermediate result indicator deletion, and cache writing. Specifically, the server may sequentially calculate the data indicator based on the query result of the basic indicator and the calculation model. After completing the calculation of the data indicator, the intermediate result indicator may be deleted. For example, the server may determine the data indicator to be returned based on the “measures” field in the domain model and delete the remaining intermediate result indicators. Subsequently, the server may write the obtained query result of the data indicator into the cache.

In addition, during the post-processing and output stage, the server may perform several steps including post-pipeline processing, chart generation, and chart presentation. Specifically, the server may perform post-pipeline processing on the query result of the data indicator based on the filtering condition, sorting condition, number limit, etc. in the data analysis request, generate a chart corresponding to the type of the data indicator, and present the chart to the user.

The method constructs the calculation model that includes the dependency relationship between the data indicator and other indicators, thus obtaining the basic indicator on which the data indicator depends by analyzing the calculation model. In this way, the query result of the basic indicator can be calculated based on the calculation model to obtain the query result of the data indicator, thereby causing the configuration and calculation of the data indicator more flexible, supporting data analysis of data indicators with complex nested relationships, and meeting various business requirements.

The data analysis method provided by the embodiments of the present disclosure is introduced in detail above with reference to FIG. 1 to FIG. 7. The apparatus and device provided by the embodiments of the present disclosure will be introduced below with reference to the drawings.

Referring to a schematic structural diagram of a data analysis apparatus shown in FIG. 8, the data analysis apparatus may be a software apparatus, and the software apparatus is deployed in a device to implement the data analysis method corresponding to the embodiment shown in FIG. 2. In some embodiments, the data analysis apparatus may also be a hardware apparatus, and the apparatus 800 includes:
an acquisition unit 802, configured to acquire a data analysis request, in which the data analysis request includes at least one data indicator;
an analyzing unit 804, configured to analyze the at least one data indicator according to a calculation model of the at least one data indicator to obtain a basic indicator on which the at least one data indicator depends, in which the calculation model includes a dependency relationship between the at least one data indicator and the basic indicator; and
a calculation unit 806, configured to, according to a query result of the basic indicator, perform calculation on the query result of the basic indicator through the calculation model to obtain a query result of the at least one data indicator.

In some possible implementations, the apparatus 800 further includes:
a construction unit 803, configured to receive an attribute of the at least one data indicator configured by a user through a configuration interface, in which the attribute includes an identification and a calculation method of the at least one data indicator; and construct the calculation model of the at least one data indicator based on the identification and the calculation method.

In some possible implementations, the analyzing unit 804 is specifically configured to:
determine, according to the calculation model of the at least one data indicator, an indicator on which the at least one data indicator depends, in which the indicator on which the at least one data indicator depends includes one or more of an intermediate result indicator and a basic indicator; and
filter the basic indicator on which the at least one data indicator depends, from the indicator on which the at least one data indicator depends.

In some possible implementations, the indicator on which the at least one data indicator depends includes an intermediate result indicator and a basic indicator, and the calculation unit 806 is specifically configured to:
according to the query result of the basic indicator, perform calculation on the query result of the basic indicator based on a dependency relationship between the intermediate result indicator and the basic indicator, to obtain a query result of the intermediate result indicator; and
perform calculation on the query result of the intermediate result indicator based on a dependency relationship between the at least one data indicator and the intermediate result indicator, to obtain the query result of the at least one data indicator.

In some possible implementations, the apparatus 800 further includes:
a conversion unit 807, configured to convert the calculation model of the at least one data indicator into a domain model, in which the domain model includes an indicator on which the at least one data indicator depends and a calculation method of the at least one data indicator;
the calculation unit 806 is specifically configured to:
according to the query result of the basic indicator, perform calculation on the query result of the basic indicator, based on the indicator on which the at least one data indicator depends in the domain model and the calculation method of the at least one data indicator in the domain model, to obtain the query result of the at least one data indicator.

In some possible implementations, the apparatus 800 further includes:
a presentation unit 805, configured to generate a chart corresponding to a type of the at least one data indicator according to the query result of the at least one data indicator; and present the chart corresponding to the type of the at least one data indicator to a user.

In some possible implementations, the calculation model of the at least one data indicator is represented by a directed acyclic graph (DAG), a vertex of the DAG represents the identification, and an edge of the DAG represents the calculation method.

The data analysis apparatus 800 according to the embodiments of the present disclosure may correspondingly perform the method described in the embodiments of the present disclosure, and the above and other operations and/or functions of the various modules/units of the data analysis apparatus 800 are for realizing the corresponding processes of the various methods of the embodiment shown in FIG. 2, respectively, which will not be repeated here for the sake of brevity.

Additionally, the embodiments of the present disclosure further provide a device, and the device includes a processor and a memory. The memory is configured to store instructions or a computer program, and the processor is configured to execute the instructions or computer program stored in the memory, to enable the device to perform any one of the data analysis methods provided by the embodiments of the present disclosure.

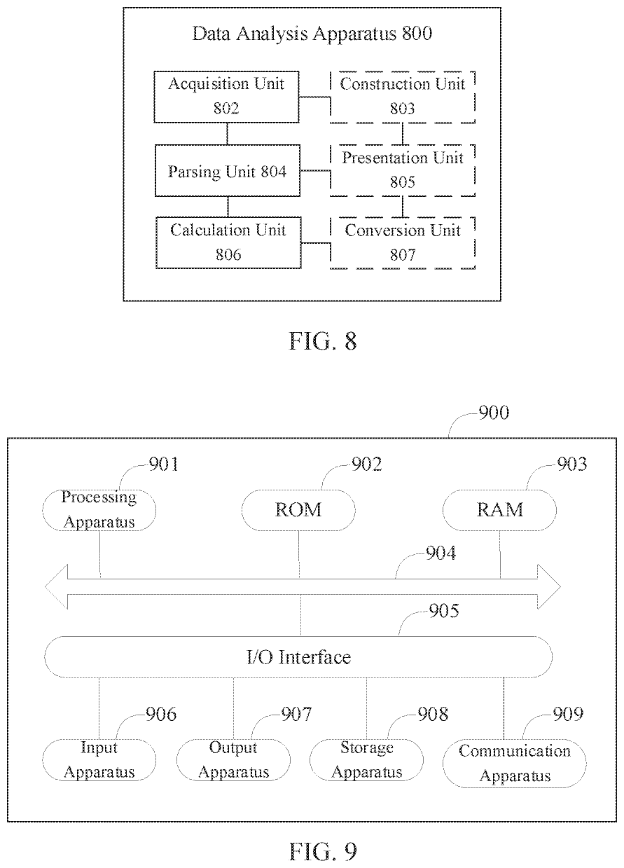

Referring to FIG. 9, FIG. 9 illustrates a schematic structural diagram of a device 900 suitable for implementing the embodiments of the present disclosure. The device in the embodiments of the present disclosure may include but is not limited to a mobile terminal such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), and a fixed terminal such as a digital TV, a desktop computer, or the like. The device illustrated in FIG. 9 is merely an example, and should not pose any limitation to the functions and the using range of the embodiments of the present disclosure.

As illustrated in FIG. 9, the device 900 may include a processing apparatus 901 (e.g., a central processing unit, a graphics processing unit, etc.), which can perform various suitable actions and processing according to a program stored in a read-only memory (ROM) 902 or a program loaded from a storage apparatus 908 into a random-access memory (RAM) 903. The RAM 903 further stores various programs and data required for operations of the device 900. The processing apparatus 901, the ROM 902, and the RAM 903 are connected to each other through a bus 904. An input/output (I/O) interface 905 is also connected to the bus 904.

Usually, the following apparatuses may be connected to the I/O interface 905: an input apparatus 906 including, for example, a touch screen, a touch pad, a keyboard, a mouse, a camera, a microphone, an accelerometer, a gyroscope, or the like; an output apparatus 907 including, for example, a liquid crystal display (LCD), a loudspeaker, a vibrator, or the like; a storage apparatus 908 including, for example, a magnetic tape, a hard disk, or the like; and a communication apparatus 909. The communication apparatus 909 may allow the device 900 to be in wireless or wired communication with other devices to exchange data. FIG. 9 illustrates the device 900 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure provide a computer program product, which includes a computer program carried by a non-transitory computer-readable medium. The computer program includes program codes for performing the method shown in the flowchart. In such embodiments, the computer program can be downloaded online through the communication apparatus 909 and installed, or can be installed from the storage apparatus 908, or can be installed from the ROM 902. When the computer program is executed by the processing apparatus 901, the above-mentioned functions defined in the methods of the embodiments of the present disclosure are performed.

The device provided by the embodiments of the present disclosure and the method provided by the above embodiments belong to the same inventive concept, and technical details not exhaustively described in the present embodiment may be referred to the above embodiments, and the present embodiment has the same beneficial effects as the above embodiments.

The embodiments of the present disclosure further provide a computer-readable medium, the computer-readable medium stores instructions or computer programs. When the instructions or computer programs are run on a device, the device can perform any one of the data analysis methods provided by the embodiments of the present disclosure.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the device, the device can perform the above-mentioned method.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

It should be noted that the various embodiments in the present disclosure are described in a progressive manner, each embodiment focuses on the differences from other embodiments, and similar parts between the various embodiments may be referred to each other. For the systems or apparatuses disclosed in the embodiments, because they correspond to the methods disclosed in the embodiments, the description is relatively simple, and the relevant parts may refer to the description of the methods for details.

It should be understood that, in the present disclosure, “at least one (item)” refers to one or more, and “a/the plurality of” refers to two or more. “And/or” is used to describe the association relationship between associated objects, indicating that there may be three relationships. For example, “A and/or B” may indicate: only A exists, only B exists, and both A and B exist simultaneously, in which A, B may be singular or plural. The character “/” generally indicates that the associated objects before and after are in a kind of “or” relationship. “At least one of (items)” or similar expressions refer to any combination of these items, including any combination of single (item) or multiple (items). For example, at least one (item) of a, b, and c may indicate: a, b, c, “a and b”, “a and c”, “b and c”, or “a, b, and c”, in which a, b, and c may be singular or plural.

It should be noted that in the present disclosure, relational terms such as “first”, “second”, etc. are only used to distinguish one entity or operation from another entity or operation, and do not necessarily require or imply the existence of any actual relationship or order between these entities or operations. Furthermore, the terms “comprise”, “comprising”, “include”, “including”, etc., or any other variant thereof are intended to cover non-exclusive inclusion, such that a process, method, article or device comprising a set of elements includes not only those elements, but also other elements not expressly listed, or other elements not expressly listed for the purpose of such a process, method, article or device, or elements that are inherent to such process, method, article or device. Without further limitation, an element defined by the phrase “includes a . . . ” does not preclude the existence of additional identical elements in the process, method, article or device that includes the element.

The steps of the methods or algorithms described in the embodiments of the present disclosure may be implemented directly with hardware, software modules executed by a processor, or a combination of both. The software modules may be placed in the random access memory (RAM), memory, read-only memory (ROM), electrically programmable ROM, electrically erasable programmable ROM, registers, hard disks, removable disks, CD-ROMs, or any other form of storage medium known in the art.

The above-mentioned descriptions of the disclosed embodiments enable those skilled in the art to implement or use the present disclosure. Various modifications to these embodiments will be readily apparent to those skilled in the art, and the generic principles defined herein may be practiced in other embodiments without departing from the spirit or scope of the present disclosure. Therefore, the present disclosure is not limited to the embodiments described herein but is to be accorded the widest scope consistent with the principles and novel features disclosed herein.

1. A data analysis method, comprising:
acquiring a data analysis request, wherein the data analysis request comprises at least one data indicator;
analyzing the at least one data indicator according to a calculation model of the at least one data indicator to obtain a basic indicator on which the at least one data indicator depends, wherein the calculation model comprises a dependency relationship between the at least one data indicator and the basic indicator; and
according to a query result of the basic indicator, performing calculation on the query result of the basic indicator through the calculation model to obtain a query result of the at least one data indicator.

2. The method according to claim 1, further comprising:
receiving an attribute of the at least one data indicator configured by a user through a configuration interface, wherein the attribute comprises an identification and a calculation method of the at least one data indicator; and
constructing the calculation model of the at least one data indicator according to the identification and the calculation method.

3. The method according to claim 1, wherein the analyzing the at least one data indicator according to the calculation model of the at least one data indicator to obtain the basic indicator on which the at least one data indicator depends, comprises:
according to the calculation model of the at least one data indicator, determining an indicator on which the at least one data indicator depends, wherein the indicator on which the at least one data indicator depends comprises one or more of an intermediate result indicator and a basic indicator; and
filtering the basic indicator on which the at least one data indicator depends, from the indicator on which the at least one data indicator depends.

4. The method according to claim 1, wherein the indicator on which the at least one data indicator depends comprises an intermediate result indicator and a basic indicator, and according to the query result of the basic indicator, the performing calculation on the query result of the basic indicator through the calculation model to obtain the query result of the at least one data indicator, comprises:
according to the query result of the basic indicator, performing calculation on the query result of the basic indicator based on a dependency relationship between the intermediate result indicator and the basic indicator, to obtain a query result of the intermediate result indicator; and
performing calculation on the query result of the intermediate result indicator based on a dependency relationship between the at least one data indicator and the intermediate result indicator, to obtain the query result of the at least one data indicator.

5. The method according to claim 1, further comprising:
converting the calculation model of the at least one data indicator into a domain model, wherein the domain model comprises an indicator on which the at least one data indicator depends and a calculation method of the at least one data indicator; and
according to the query result of the basic indicator, the performing calculation on the query result of the basic indicator through the calculation model to obtain the query result of the at least one data indicator, comprises:
according to the query result of the basic indicator, performing calculation on the query result of the basic indicator based on the indicator on which the at least one data indicator depends in the domain model and the calculation method of the at least one data indicator in the domain model, to obtain the query result of the at least one data indicator.

6. The method according to claim 1, further comprising:
generating a chart corresponding to a type of the at least one data indicator according to the query result of the at least one data indicator; and
presenting the chart corresponding to the type of the at least one data indicator to a user.

7. The method according to claim 1, wherein the calculation model of the at least one data indicator is represented by a directed acyclic graph DAG, a vertex of the DAG represents an identification, and an edge of the DAG represents a calculation method.

8. A data analysis apparatus, comprising:
an acquisition unit, configured to acquire a data analysis request, wherein the data analysis request comprises at least one data indicator;
an analyzing unit, configured to analyze the at least one data indicator according to a calculation model of the at least one data indicator to obtain a basic indicator on which the at least one data indicator depends, wherein the calculation model comprises a dependency relationship between the at least one data indicator and the basic indicator; and
a calculation unit, configured to, according to a query result of the basic indicator, perform calculation on the query result of the basic indicator through the calculation model to obtain a query result of the at least one data indicator.

9. A device, comprising a processor and a memory,
wherein the processor is configured to execute instructions stored in the memory to allow the device to perform a data analysis method, the method comprises:
acquiring a data analysis request, wherein the data analysis request comprises at least one data indicator;
analyzing the at least one data indicator according to a calculation model of the at least one data indicator to obtain a basic indicator on which the at least one data indicator depends, wherein the calculation model comprises a dependency relationship between the at least one data indicator and the basic indicator; and
according to a query result of the basic indicator, performing calculation on the query result of the basic indicator through the calculation model to obtain a query result of the at least one data indicator.

10. The device according to claim 9, further comprising:
receiving an attribute of the at least one data indicator configured by a user through a configuration interface, wherein the attribute comprises an identification and a calculation method of the at least one data indicator; and
constructing the calculation model of the at least one data indicator according to the identification and the calculation method.

11. The device according to claim 9, wherein the analyzing the at least one data indicator according to the calculation model of the at least one data indicator to obtain the basic indicator on which the at least one data indicator depends, comprises:
according to the calculation model of the at least one data indicator, determining an indicator on which the at least one data indicator depends, wherein the indicator on which the at least one data indicator depends comprises one or more of an intermediate result indicator and a basic indicator; and
filtering the basic indicator on which the at least one data indicator depends, from the indicator on which the at least one data indicator depends.

12. The device according to claim 9, wherein the indicator on which the at least one data indicator depends comprises an intermediate result indicator and a basic indicator, and according to the query result of the basic indicator, the performing calculation on the query result of the basic indicator through the calculation model to obtain the query result of the at least one data indicator, comprises:
according to the query result of the basic indicator, performing calculation on the query result of the basic indicator based on a dependency relationship between the intermediate result indicator and the basic indicator, to obtain a query result of the intermediate result indicator; and
performing calculation on the query result of the intermediate result indicator based on a dependency relationship between the at least one data indicator and the intermediate result indicator, to obtain the query result of the at least one data indicator.

13. The device according to claim 9, further comprising:
converting the calculation model of the at least one data indicator into a domain model, wherein the domain model comprises an indicator on which the at least one data indicator depends and a calculation method of the at least one data indicator; and
according to the query result of the basic indicator, the performing calculation on the query result of the basic indicator through the calculation model to obtain the query result of the at least one data indicator, comprises:
according to the query result of the basic indicator, performing calculation on the query result of the basic indicator based on the indicator on which the at least one data indicator depends in the domain model and the calculation method of the at least one data indicator in the domain model, to obtain the query result of the at least one data indicator.

14. The device according to claim 9, further comprising:
generating a chart corresponding to a type of the at least one data indicator according to the query result of the at least one data indicator; and
presenting the chart corresponding to the type of the at least one data indicator to a user.

15. The device according to claim 9, wherein the calculation model of the at least one data indicator is represented by a directed acyclic graph DAG, a vertex of the DAG represents an identification, and an edge of the DAG represents a calculation method.

16. A computer-readable storage medium, comprising instructions, wherein the instructions are configured to instruct a device to perform the method according to claim 1.
